(19) United States
(12) Patent Application Publication
(10) Pub. No.: US 2008/0056159 A1
(43) Pub. Date: Mar. 6, 2008

(54) METHOD FOR SETTING PATH AND NODE APPARATUS

(76) Inventors: Motoki Suzuki, Yokohama (JP); Yasuyuki Fukashiro, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/753,001

(22) Filed: May 24, 2007

(30) Foreign Application Priority Data
Sep. 1, 2006 (JP) 2006-237758

(51) Int. Cl. H04L 12/28

(52) U.S. Cl. 370/254

(57) ABSTRACT

In a GMPLS node provided with inter-node control protocols including GMPLS, when an adjacent node is in a failure state, path establishment is automatically accomplished by providing a temporary reply to a path establishment request source node in response to a path establishment request, securing a source of an intermediate route, repeatedly transmitting a path establishment request to the adjacent node in the failure state according to specified conditions after completion of temporary path establishment, performing a path establishment process for the remaining section when the adjacent node recovers from the failure, and then transmitting a path establishment completion notification message to the request source node.

### CLAIM OF PRIORITY

The present application claims priority from Japanese patent application serial no. 2006-237758, filed on Sep. 1, 2006, the content of which is hereby incorporated by reference into this application.

### BACKGROUND OF THE INVENTION

The present invention relates to a method for setting a path and to a node apparatus, which are used in optical transmission systems for backbone networks covering within and between countries, metro networks in urban areas, or provincial networks. More particularly, the invention relates to a method for setting a path and to a node apparatus, which can establish a route to a node adjacent to a destination node even if a signaling signal may not be transmitted to the destination node.

Recently a technology for inter-node connection control has been extensively studied in the transmission device. An example of the inter-node control technology is GMPLS (Generalized Multi-Protocol Label Switching) technology that establishes a communication route by a label in a communication network formed by the transmission device and other devices. The GMPLS technology is described in Non-patent document 1 (RFC3945) E. Mannie, “Generalized Multi-Protocol Label Switching (GMPLS) Architecture”, October 2004, IETF. This technology is expected as a method for realizing effective management of networks on which various devices are available, such as router, time division multiplexer, and OXC (Optical Cross-Connect)/PXC (Photonic Cross-connect) devices, to meet the needs of diversified services and increased transmission capacity.

GMPLS makes it possible to establish an LSP (Label Switched Path) by a set of labels on a communication network formed byapacket switch such as a router, a time division switch such as a SONET (Synchronous Optical Network)/SDH (Synchronous Digital Hierarchy) device, and a wavelength or waveband switch such as an OXC/PXC device, based on a group of protocols including a signaling protocol such as GMPLS RSVP-TE (ReserVation Protocol-Traffic Engineering), a routing protocol such as OSPF-TE (Open Shortest Path First-Traffic Engineering), and other protocols. Incidentally GMPLS RSVP-TE is described in Non-patent document 2 (RFC3473) L. Berger, “Generalized Multi-Protocol Label Switching (GMPLS) Signaling Resource ReserVation Protocol-Traffic Engineering (RSVP-TE) Extensions”, January 2003, IETF, and OSPF-TE is described in Non-patent document 3 (RFC3630) D. Katz, et al., “Traffic Engineering (TE) Extensions to OSPF Version 2”, September 2003, IETF.

As part of the current communication network, there is a monitoring controller such as an NMS (Network Management System) using protocols such as SNMP (Simple Network Management Protocol), TL1 (Transaction Language 1), and CMIP (Common Management Information Protocol), serving as a management device for intensively managing the communication network.

Further a technology is being devised to consistently establish, in a source device, an LSP to a destination client, including a core network formed by SONET/SDH, OXC/PXC and the like, using GMPLS and user control protocols such as O-UNI (Optical-User Network Interface, OIF-UNI-01.0 R2), and GMPLS UNI. Incidentally OIF-UNI-01.0 R2 is described in Non-patent document 4, “User Network Interface (UNI) 1.0 Signaling Specification, Release 2”, Feb. 27, 2004, OIF, and GMPLS UNI is described in Non-patent document 5 (RFC 4208), G. Swallow, et al., “Generalized Multiprotocol Label Switching (GMPLS) User-Network Interface (UNI): Resource ReserVation Protocol-Traffic Engineering (RSVP-TE) Support for the Overlay Model”, October 2005, IETF.

Further a study for LlVPN (Layer 1 Virtual Private Network) and other application services is actively pursued using the above described services. There are new services being studied for L1VPN, such as multi-service backbone, carrier's carrier, and rental of Layer 1 resources. L1VPN is described in Non-patent document 6 (Y.1312) “ITU-T Recommendation Y.1312 Layer 1 Virtual Private Network generic requirements and architecture elements”, September 2003, ITU-T, and in Non-patent document 7 (Y.1313) “ITU-T Recommendation Y.1313 Layer 1 Virtual Private Network service and network architectures”, July 2004, ITU-T.

In Patent document 1 (JP-A No. 258880/2003), there is disclosed an invention directed to a method in which a source node that transmitted a path connection request starts data transfer after a predetermined period of time elapsed without waiting for a reply to the connection request, in order to reduce the time from when a user requests data transfer to when the data transfer is actually started.

In the GMPLS network using the user control protocols such as O-UNI and GMPLS UNI, a label is secured end to end to consistently manage operations including establishment and deletion of a path as an LSP. Further in the GMPLS network, the label is secured according to the control protocols between each of the nodes to provide inter-node control. However, the control signal line for inter-node control is not necessarily the same line as the main signal line that conveys user data. Thus even if the main signal line is in normal state, the inter-node control may be disabled when a failure occurs in the control signal line and the like. For this reason, although the path establishment is performed when the control signal line of the destination node is in a failure state or other undesired state, an error is replied and the path is not currently established.

Further the GMPLS network accommodates plural users for the purpose of improving the usability of resources. However, in the GMPLS, since the resources are dynamically and unexpectedly reserved and allocated depending on the usage pattern, a competition may occur in the utilization of resources. For example, when the path is temporarily interrupted so that an alternative route is selected in a lower layer due to a failure of the destination node or other reason, the resource of the intermediate route, which has been used until now, may be occupied by another user who established a path. This leads to a problem that when the path is attempted to be reestablished, the path may not be established or may be established on another route than the previous one.

Further when a route is secured as a path to the adjacent node of the destination node and when the destination node returns to normal state, the secured path is necessary to be once deleted to reestablish the path. Thus it is difficult to automatically recover the path after the destination node is recovered from the failure. There is also a case where the intermediate route is secured when the communication is disabled due to a failure in the destination node or other reason, although it is difficult to confirm normality of the main signal. In this case the failure within the GMPLS network is detected in the lower layer as the main signal traffic to the destination node flows on the intermediate route, which leads to another problem of delay in starting the traffic protection, such as alternate route calculation, in the lower layer.

### SUMMARY OF THE INVENTION

The present invention solves the above described problems, even with a failure of the destination node or of the control signal line of the destination node, by establishing a temporary path to a node adjacent to the destination node, notifying a request source node that the temporary path is partially established, monitoring the failure state of the destination node by the adjacent node, providing path establishment control to the destination node when the destination node returns to a normal state, and transmitting a path establishment completion message to the request source node. The present invention will be described more in detail below.

First, each node is provided with a communication interface for inter-node control signals, through which control messages including a path establishment can be exchanged. A GMPLS node adjacent to a user node monitors the state of the adjacent node through the inter-node control signals, so that a failure of the adjacent node can be detected.

Second, even if the destination node is in a failure state, the path establishment request source transmits an enforcement path establishment message including a mode specification to forcibly establish a path, so that the resource of the intermediate route can be secured. The enforcement path establishment message includes the retry count of a process for establishing a path to the destination user node, the retry interval, and other conditions. This makes it possible to automate the path establishment to the destination node when the destination node is recovered to normal state within the specified conditions.

Third, when the destination node is in a failure state, the adjacent node of the destination node, which received the enforcement path establishment message, transmits a temporary path establishment completion reply message including information indicating that only the intermediate route has been secured. This makes it possible for the request source node to recognize that the path is in an incomplete state.

Fourth, when the retry process of enforcement path establishment to the destination node was performed within the specified conditions but the destination node is not recovered to normal state and the path establishment to the destination node is failed, the adjacent node of the destination node provides an error reply to release the resource of the intermediate route and notifies the request source node of the path establishment failure. This makes it possible to avoid unnecessary occupation of the resource of the intermediate route.

Fifth, each node is provided with an external communication interface to which a monitoring controller is connected, thereby to notify the monitoring controller of the state change such as a failure. This makes it possible to provide failure notification to an operator when a failure of the adjacent node is detected or when the path establishment is failed in enforcement mode.

The above can be achieved by a method for setting a path that includes the steps of: upon reception of a first path establishment request of enforcement mode, transmitting a second path establishment request to an adjacent node; determining a failure of the adjacent node; upon determination that a failure exists in communication with the adjacent node, transmitting a temporary path establishment reply to a source of the first path establishment request; and upon reception of completion of the temporary path establishment from the source, transmitting a third path establishment request to the adjacent node according to conditions described in the temporary path establishment completion.

Further, the above can be achieved by a node apparatus including a message reception unit, a message transmission unit, and an adjacent node state determination unit. When the message reception unit receives a first path establishment request of enforcement mode, the message transmission unit transmits a second path establishment request to the adjacent node. When the adjacent node state determination unit determines that a failure exists in communication with the adjacent node, the message transmission unit transmits a temporary path establishment reply to the source of the first path establishment request. When the message reception unit receives completion of temporary path establishment from the source, the message transmission unit transmits a third path establishment request to the adjacent node according to conditions described in the temporary path establishment completion.

### BRIEF DESCRIPTION OF THE DRAWINGS

Preferred embodiments of the present invention will now be described in conjunction with the accompanying drawings, in which:

FIG. 1 is a block diagram of a communication network;

FIG. 2 is a block diagram showing an example of the detailed network configuration in the communication network;

FIG. 3 is a block diagram of a GMPLS node;

FIG. 4 is a block diagram of a user node;

FIG. 5 is a block diagram of a monitoring controller;

FIG. 6 is a transition diagram illustrating a path establishment process;

FIG. 7 is a flowchart of a process for establishing a path in the GMPLS node;

FIG. 8 is a view illustrating a message format of an inter-node control protocol;

FIG. 9 is a view illustrating the object contents of the inter-node control protocol;

FIG. 10 is a transition diagram illustrating an enforcement path establishment process; and

FIG. 11 is a transition diagram illustrating another enforcement path establishment process.

### DETAILED DESCRIPTION OF THE PREFERRED EMBODIMENTS

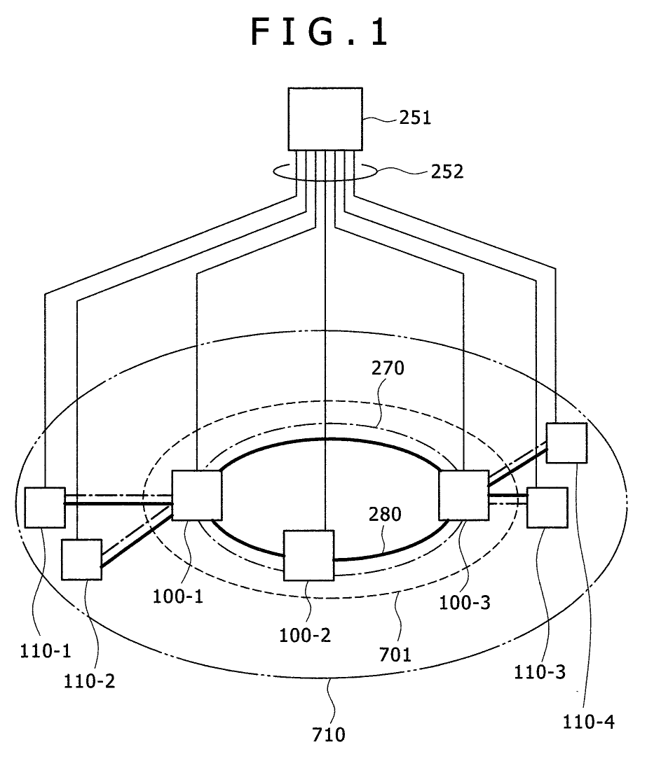

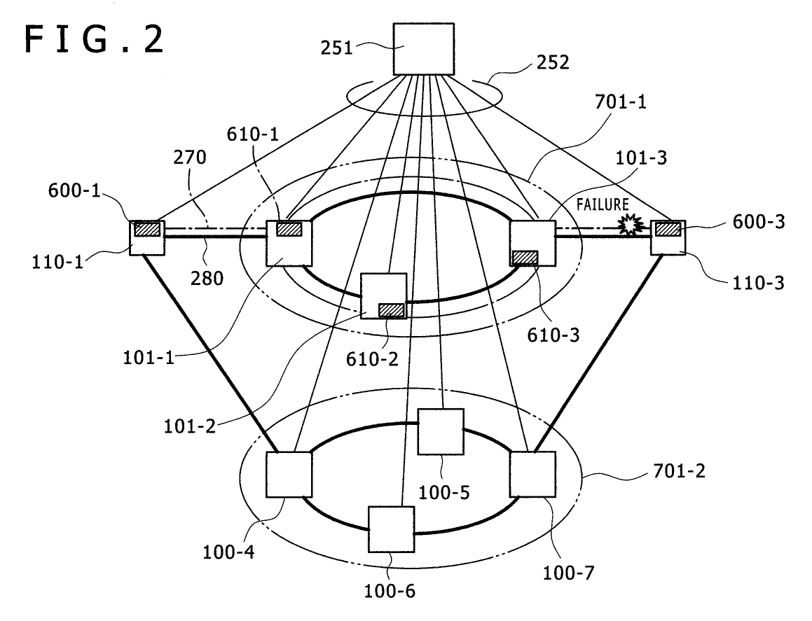

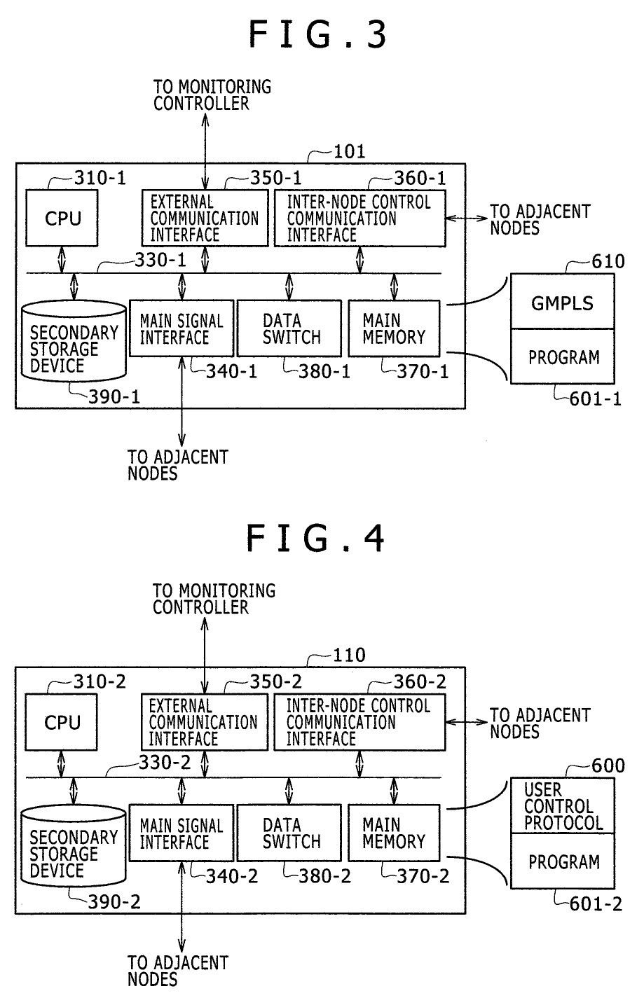

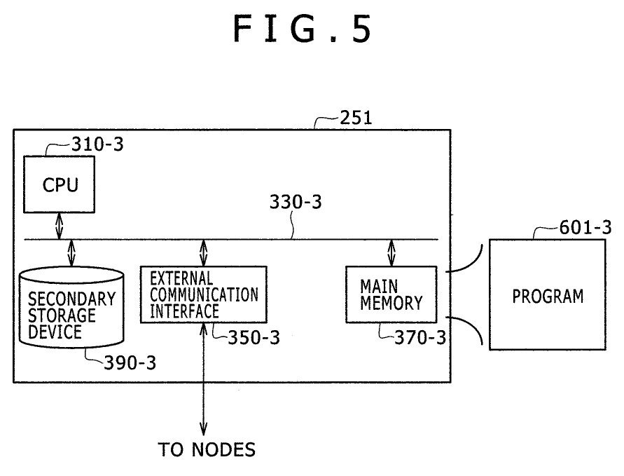

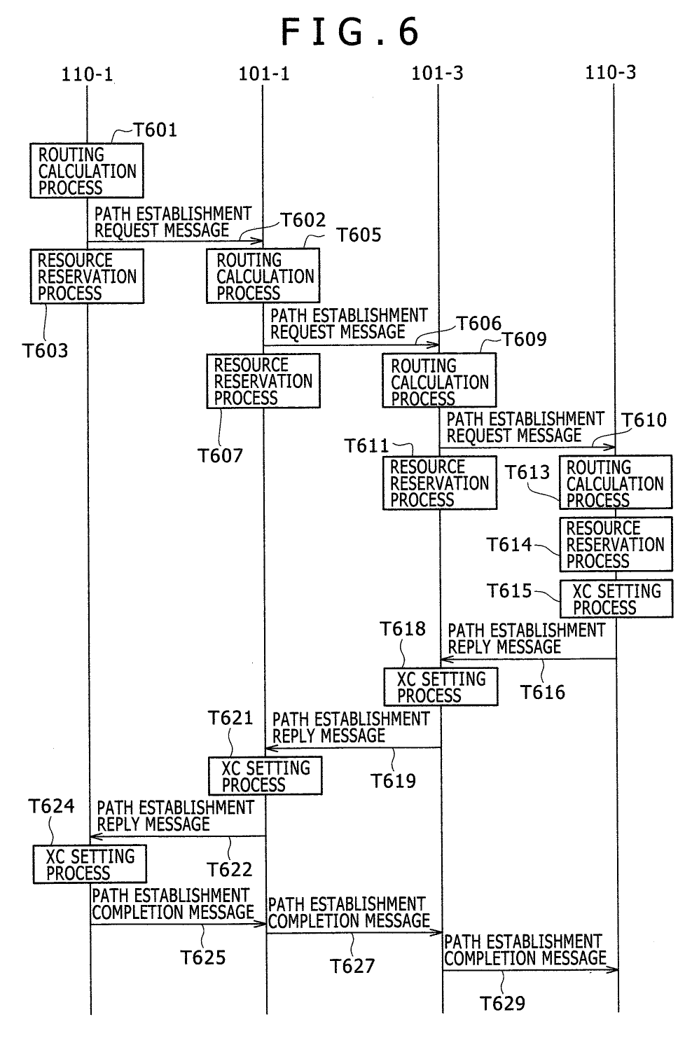

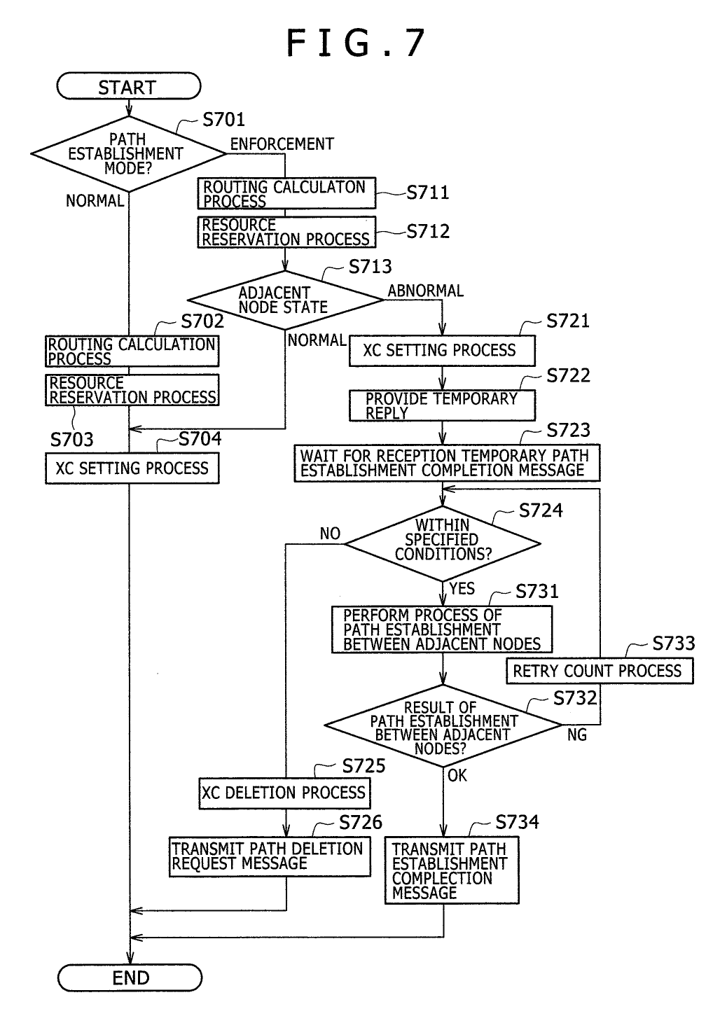

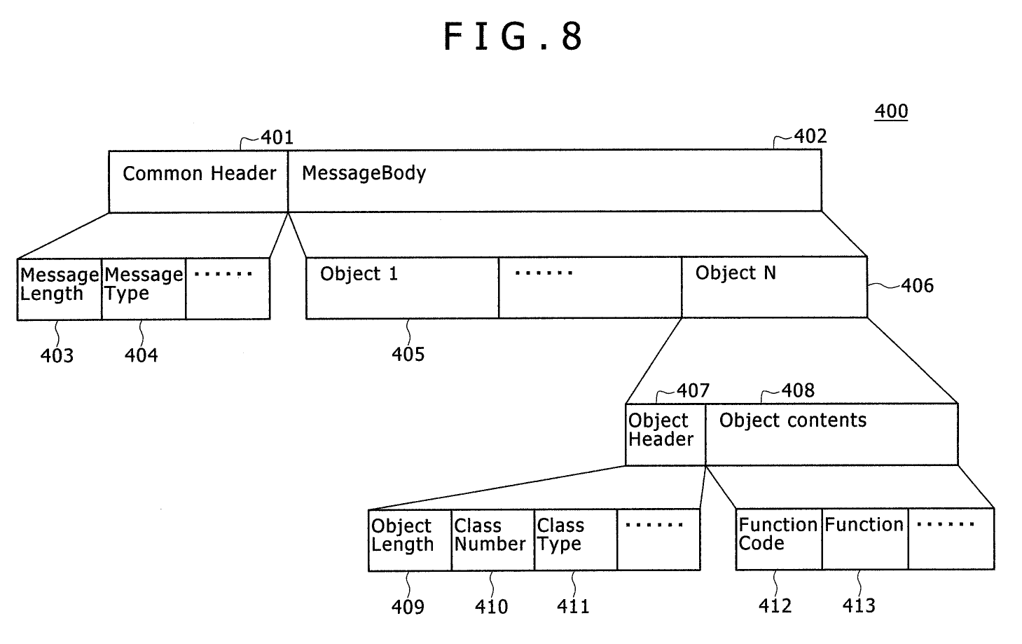

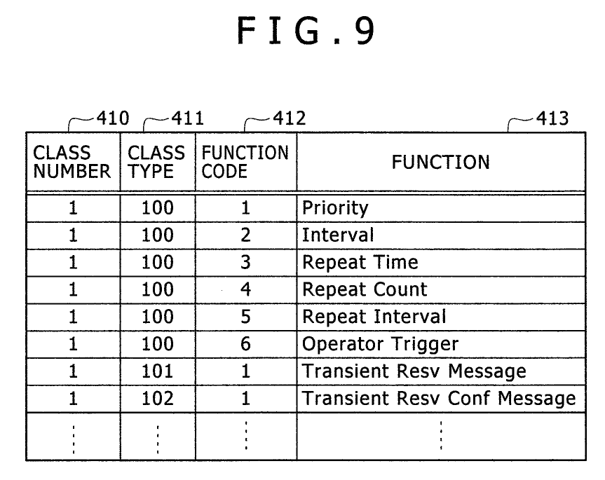

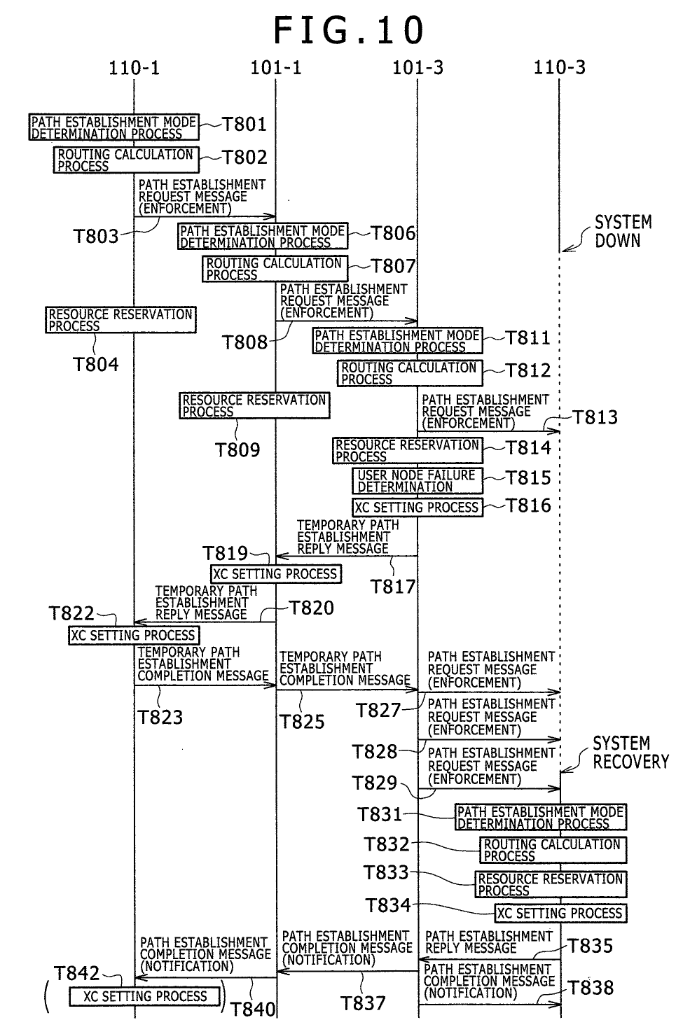

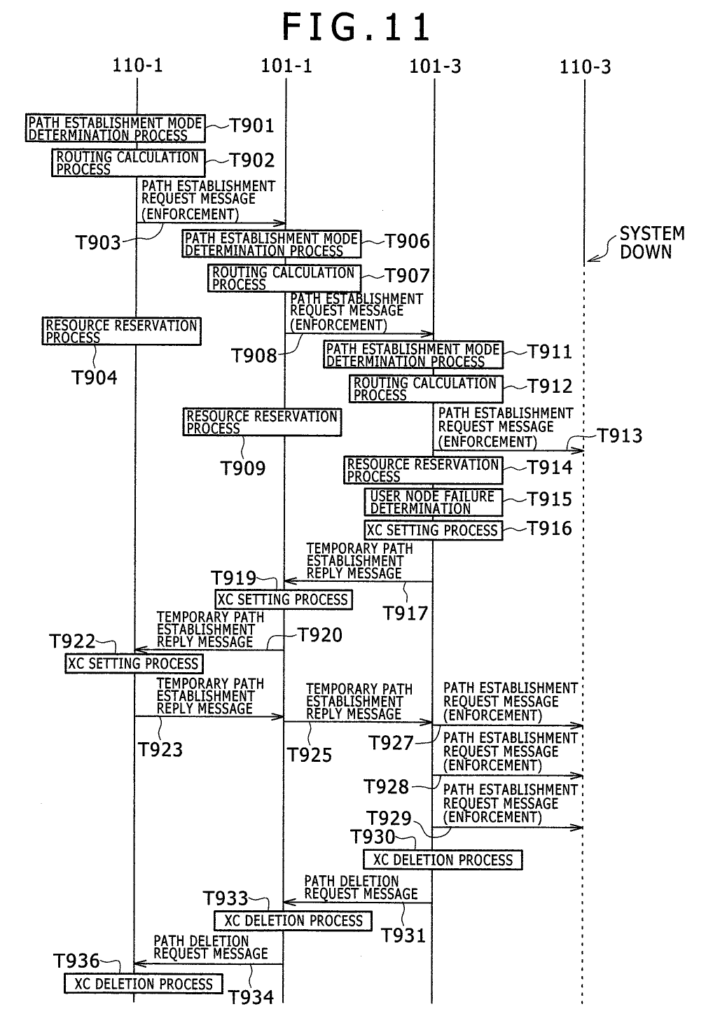

Modes for carrying out the invention will be described below based on preferred embodiments with reference to FIGS. 1 to 11. Incidentally, substantially like parts are denoted by like reference numerals and the description will not be repeated. Here, FIG. 1 is a block diagram of a communication network. FIG. 2 is a block diagram showing a detailed network configuration in the communication network. FIG. 3 is a block diagram of a GMPLS node. FIG. 4 is a block diagram of a user node. FIG. 5 is a block diagram of a monitoring controller. FIG. 6 is a transition diagram illustrating a path establishment process. FIG. 7 is a flowchart of a process for establishing a path in the GMPLS node. FIG. 8 is a view illustrating a message format of an inter-node control protocol. FIG. 9 is a view illustrating the object contents of the inter-node control protocol. FIG. 10 is a transition diagram illustrating an enforcement path establishment process. FIG. 11 is a transition diagram illustrating another enforcement path establishment process.

It is to be noted that communication devices such as the GMPLS node and user node are generally referred to as nodes, unless they need to be differentiated.

First a communication network will be described with reference to FIG. 1. A communication network 710 shown in FIG. 1 includes a core network 701 formed by nodes 100-1 to 100-3 such as routers, Layer 2 Switches, Layer 3 Switches, WDM (Wavelength Division Multiplexing) devices, SONET/SDH devices, and OXC/PXC devices. The nodes 100 are connected to user nodes 110-1 to 110-4, such as routers, Layer 2 Switches, Layer 3 Switches, WDM devices, SONET/SDH devices, and OXC/PXC devices, through a control channel 270 and a main signal line 280.

Incidentally the control channel 270 at least can realize a logical connection between each of the nodes. In other words, the control channel 270 may be the same line as the main signal line 280, using multiplex systems such as optical wavelength multiplexing or time division multiplexing, together with OSC (Optical Supervisory Channel) and the like. Also the control channel 270 may be formed by an individual line network different from the main signal line 280.

The nodes 100 and the user nodes 110 are connected to a monitoring controller 251 through a control signal line 252. Incidentally plural monitoring controllers may be prepared according to necessity. The control signal line 252 at least can realize a logical connection between the monitoring controller and the respective nodes. The control signal line 252 may use wired communication systems such as ISDN (Integrated Services Digital Network), frame relay network, and other various private lines, or wireless communication systems using a wireless LAN (Local Area Networks) such as IEEE (Institute of Electrical and Electronics Engineers) 802.11, and other wireless technologies.

In FIG. 2, the user nodes 110-1 and 110-3 are connected through both a core network (working) 701-1 and a core network (backup) 701-2, making the communication network 710 redundant. When a failure occurs within the core network (working) 701-1, the user nodes 110-1 and 110-3 switch to the communication in the core network (backup) 701-2. The user nodes 110-1 and 110-3 are provided with user control protocols 600-1 and 600-3 as programs, respectively. The user control protocols used herein may include such protocols as RSVP-TE, GMPLS-UNI, and O-UNI.

The core network (working) 701-1 is formed by the GMPLS nodes 101-1 to 101-3 provided with GMPLSs 610-1 to 610-3 as programs, respectively.

The programs in the embodiment may be realized by a hardware process of FPGA (Field Programmable Gate Array), DSP (Digital Signal Processor), or a network processor according to necessity.

The user nodes 110-1, 110-3 and the GMPLS nodes 101-1 to 101-3 perform an inter-node control communication, such as GMPLS, through the control channel 270. The control channel 270 that logically connects between the respective nodes may be formed by an individual line network different from the main signal line 280, or may provide the connection through the main signal line 280.

The core network (backup) 701-2 is formed by the nodes 100-4 to 100-7. The core network (backup) 701-2 may be used to disperse the communication load of the core network (working) 701-1 in normal operation. Further the core network (backup) 701-2 may be a system that secures the resource and establishes a communication route, upon occurrence of a failure in communication through the core network (working) 701-1. Further the core network (backup) 701-2 may provide inter-node control, using GMPLS and the like in a similar way to the core network (working) 701-1.

Incidentally, in FIG. 7, a description will be made with respect to a failure of the control channel 270 between the GMPLS node 101-3 and the user node 110-3.

Next the hardware configuration of the GMPLS node will be described with reference to FIG. 3. In FIG. 3, the GMPLS node 101 includes a central processing unit (CPU) 310-1, an internal communication line 330-1 such as a bus, an external communication interface 350-1, an inter-node control communication interface 360-1, a secondary storage device 390-1, a main signal interface 340-1, a data switch 380-1, and a main memory 370-1.

The main memory 370-1 is a rewritable semiconductor memory such as RAM, storing a program 601-1 and a GMPLS protocol 610 that are executed by the central processing unit (CPU) 310-1.

The secondary storage device 390-1 includes a rewritable nonvolatile semiconductor memory, a hard disk, and the like. Examples of the rewritable nonvolatile semiconductor memory are Flash ROM, Compact Flash, SSFDC (Solid State Floppy (registered trade mark) Disk Card), and SD memory card (Secure Digital memory card). The secondary storage device 390-1 operates as a memory area of the software such as the program 601-1 and the GMPLS protocol 610. Further the secondary storage device 390-1 may also store data and logs generated by program execution. When storing data such as MAC address (Media Access Control Address) that is not needed to be updated as well as a program that is infrequently updated, the secondary storage device 390-1 may be configured using a nonvolatile ROM such as EPROM (Erasable Programmable ROM) and EEPROM (Electronically Erasable and Programmable ROM).

There may be provided plural main signal interfaces 340-1 according to necessity. The main signal interface 340-1 uses signals, such as those defined in IEEE802.3, IEEE802.3z, IEEE802.3ae, or SONET/SDH signals defined in “International Telecommunication Union Telecommunication Standardization sector” (ITU-T) G.707, G.783 and the like, or OTN (Optical Transport Network) signals defined in ITU-T G.709 and the like. The main signal interface 340-1 is connected to the other adjacent node to exchange user data. The data switch 380-1 is selected from an electric switch, an optical switch of MEMS (Micro Electro Mechanical System) type, an optical switch of PLC (Planar Lightwave Circuit) type, a time division multiplexing switch, and an ADD/DROP switch, to switch and connect the main signal.

The inter-node control communication interface 360-1 is connected to the other adjacent node to provide communication for inter-node control communication. The control signals such as the routing protocol, signaling protocol, and user protocol are exchanged through the inter-node control communication interface 360-1. The inter-node control communication interface used herein may be the same interface as the main signal interface 340-1 according to the GMPLS specifications.

The external communication interface 350-1 is logically connected to the monitoring controller 251. The external communication interface 350-1 provides event notification to the monitoring controller 251 and exchange of control signals from the monitoring controller 251, using protocols such as SNMP, TL1, and HDLC (High-level Data Link Control procedure). The program on the main memory 370-1 may execute other processes than those described above according to necessity.

Next, the hardware configuration of the user node will be described with reference to FIG. 4. In FIG. 4, the user node 110 includes a central processing unit (CPU) 310-2, an internal communication line 330-2 such as a bus, an external communication interface 350-2, an inter-node control communication interface 360-2, a secondary storage device 390-2, a main signal interface 340-2, a data switch 380-2, and a main memory 370-2.

The main memory 370-2 is a rewritable semiconductor memory, such as RAM, storing a program 601-2 and a user control protocol 600 that are executed by the central processing unit (CPU) 310-2.

The secondary storage device 390-2 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-2 operates as a memory area of the software such as the program 601-2 and the user control protocol 600. Further the secondary storage device 390-2 may also store data and logs generated by program execution. When storing data such as MAC address that is not needed to be updated as well as a program that is infrequently updated, the secondary storage device 390-2 may be configured using a nonvolatile ROM such as EPROM and EEPROM.

There may be provided plural main signal interfaces 340-2 according to necessity. The main signal interface 340-2 uses signals such as those defied in IEEE802.3, IEEE802.3z, IEEE802.3ae, or SONET/SDH signals defined in ITU-T G.707, G.783 and the like, or OTN signals defined in ITU-T G.709 and the like. The main signal interface 340-2 is connected to the other adjacent node to exchange user data. The data switch 380-2 is selected from an electric switch, an optical switch of MEMS type, an optical switch of PLC type, a time division multiplexing switch, and an ADD/DROP switch, to switch and connect the main signal.

The inter-node control communication interface 360-2 is connected to the other adjacent node to provide communication for inter-node control. The control signals such as the routing protocol, signaling protocol, and user protocol are exchanged through the inter-node control communication interface 360-2. The inter-node control communication interface 360-2 used herein may be the same interface as the main signal interface 340-2 according to the GMPLS specifications.

The external communication interface 350-2 is logically connected to the monitoring controller 251. The external communication interface 350-2 provides event notification to the monitoring controller 251 and exchange of control signals from the monitoring controller 251, using protocols such as SNMP, TL1, and HDLC. The program on the main memory 370-2 may execute other processes than those described above according to necessity.

Next, the hardware configuration of the monitoring controller will be described with reference to FIG. 5. In FIG. 5, the monitoring controller 251 includes a central processing unit (CPU) 310-3, an internal communication line 330-3 such as a bus, an external communication interface 350-3, a secondary storage device 390-3, and a main memory 370-3.

The main memory 370-3 is a rewritable semiconductor memory, such as RAM, storing a program 601-3 executed by the central processing unit (CPU) 310-3.

The secondary storage device 390-3 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-3 operates as a memory area of the software such as the program 601-3. Further the secondary storage device 390-3 may also store data and logs generated by program execution. When storing data such as MAC address that does not need to be updated as well as a program that is infrequently updated, the secondary storage device 390-3 may be configured using a nonvolatile ROM such as EPROM and EEPROM.

The external communication interface 350-3 is logically connected to the nodes. The external communication interface 350-3 receives event notifications from the nodes and exchanges control signals and other signals to the nodes, using protocols such as SNMP, TL1, and HDLC. Incidentally, the program on the main memory 370-3 may execute other processes than those described above according to necessity.

Next, the path establishment procedure between the user nodes will be described with reference to FIG. 6. In FIG. 6, the user node 110-1 receives a path establishment request with the user node 110-3 as the destination node. Upon reception of the path establishment request, the user node 110-1 performs a routing calculation process, and selects the GMPLS node 101-1 as the transfer destination of a path establishment message (T601). The client device 110-1 transmits the path establishment request message to the GMPLS node 101-1 (T602). The user node 110-1 performs a resource reservation process of the own node (T603).

After receiving the path establishment request message, the GMPLS node 101-1 performs a routing calculation process within the core network according to the GMPLS specifications (T605). After determining the route within the core network, the GMPLS node 101-1 transmits a path establishment request message to the GMPLS node 101-3 as the next node (T606). The GMPLS node 101-1 performs the resource reservation process (T607).

After receiving the path establishment request message, the GMPLS node 101-3 performs the routing calculation process, and selects the user node 110-3 as the transfer destination of a path establishment request message (T609). The GMPLS node 101-3 transmits the path establishment request message to the user node 110-3 (T610), and then performs the resource reservation process (T611).

Incidentally the nodes may perform the resource reservation process before transmitting the path establishment request message.

Upon reception of the path establishment request message, the user node (client device) 110-3 performs the routing calculation process (T613), resource reservation process (T614), and data switch XC (Cross Connect) setting process (T615). The resource reservation process and the XC setting process may be performed in the reverse order according to necessity. Then the user node 110-3 transmits a path establishment reply message to the GMPLS node 101-3 (T616).

The GMPLS node 101-3 receives the path establishment reply message, and performs the XC setting process to the data switch whose resource has been reserved by the resource reservation process (T618). Then the GMPLS node 101-3 transmits a path establishment reply message to the GMPLS node 101-1 (T619).

The GMPLS node 101-1 receives the path establishment reply message, and performs the XC setting process to the data switch whose resource has been reserved by the resource reservation process (T621). Then the GMPLS node 101-1 transmits a path establishment reply message to the user node 110-1 (T622). Incidentally the GMPLS node 101-1 may transmit the path establishment reply message before performing the XC setting process.

The user node 110-1 (client device) performs the XC setting process (T624), and then transmits a path establishment completion message to the GMPLS node 101-1 (T625) to notify that the path establishment is completed. The GMPLS node 101-1 receives the path establishment completion message, and transmits a path establishment completion message to the GMPLS node 101-3 (T627) to notify that the path establishment is completed. The GMPLS node 101-3 receives the path establishment completion message, and transmits a path establishment completion message to the user node 110-3 (T629) to notify that the path establishment is completed.

Incidentally the path establishment completion message may be omitted. More specifically, the each of the nodes may determine that the path generation is completed when no error reply is received for a predetermined period of time. Further the nodes may notify the monitoring controller 251 of the results of the processes as events according to necessity.

Next, referring to FIG. 7, a description will be made with respect to the enforcement path establishment process of the GMPLS node when the adjacent user node is in a failure state. Here the description is directed to the process when a failure occurs in the control channel between the GMPLS node 101-3 and the user node 110-3 as shown in FIG. 2.

Upon reception of a path establishment request message from the adjacent node, the GMPLS node 101-3 performs the path establishment mode determination process (S701). When determining that the normal mode is specified as the path establishment mode in Step 701, the GMPLS node 101-3 subsequently performs processes according to the specifications of the inter-node control protocols such as GMPLS and O-UNI. More specifically, the GMPLS node 101-3 performs the routing calculation process (S702), resource reservation process (S703), and XC setting process (S704), and then ends.

When determining that the path establishment mode is enforcement in the path establishment mode determination process in Step 701, the GMPLS node 101-3 performs the routing calculation process (S711), resource reservation process (S712), and adjacent node state determination process (S713). The adjacent node state determination process of Step 713 is a step in which the GMPLS node 101-3 transmits a path establishment request message to the adjacent node and determines that the adjacent node is abnormal when no reply is returned for a predetermined period of time or when an error reply is returned from the adjacent node. When a reply is normally returned in Step 713, the GMPLS node 101-3 determines that the adjacent node state is normal, and moves to Step 704.

On the other hand, when determining that the adjacent node is in an abnormal state in the adjacent node state determination process of Step 713, the GMPLS node 101-3 performs the XC setting process to the source of the path establishment request message (S721), and secures the resource of the intermediate route. Then the GMPLS node 101-3 provides a temporary reply to the source of the path establishment request message (S722). The temporary reply includes information from which it is possible to determine that the path establishment is incomplete.

The GMPLS node 101-3 waits for receiving a temporary path establishment completion message (S723), and performs a specified condition determination process upon reception of the temporary path establishment completion message (S724). Step 724 is a step of determining whether the path establishment meets the conditions included in the path establishment request message. When determining that the path establishment does not meet the conditions specified in the path establishment request message in Step 724, the GMPLS node 101-3 releases the resource of the intermediate route (S725), and notifies the source node of the path establishment request that the path establishment was failed (S726).

On the other hand, when determining that the path establishment is within the conditions specified in the path establishment request message in Step 724, the GMPLS node 101-3 performs a process of path establishment between adjacent nodes according to the conditions specified in the path establishment request message (S731). In the process of path establishment between adjacent nodes in Step 731, the GMPLS node 101-3 transmits a path establishment request message, and then determines the reply to the path establishment request message (S732). When determining that the adjacent node returns to the normal state in the process of node path establishment between adjacent nodes, the GMPLS node 101-3 performs the processes according to the specifications of the inter-node control protocols such as GMPLS and O-UNI. Then the GMPLS node 101-3 performs the path establishment process (transmission of a path establishment completion message) for the section in which the path was not established due to the failure of the adjacent node (S734).

On the other hand when determining that the path of the remaining section was not normally established in Step 732, the GMPLS node 101-3 increments the number of times the path establishment was failed in a retry count process (S733), and returns to Step 724.

Incidentally the GMPLS node 101-3 may notify the monitoring controller 251 of the results of the processes as events according to necessity. The adjacent node determination process of Step 713 may be performed by a message such as ping of ICMP (Internet Control Message Protocol), or using LMP (Link Management Protocol). Further the adjacent node state determination process may be performed several times in order to improve the accuracy of adjacent node state determination. The GMPLS node 101-3 may confirm the adjacent node state by a procedure equivalent to the adjacent node state determination process described above before transmitting the path establishment request message of Step 731, thereby to determine whether to transmit the path establishment request message by the adjacent node state determination process. The retry count process of Step 733 is only performed when the number of retires is specified as a condition, and may be omitted when the number of retires is not specified as the condition.

Next, each of the messages will be described with reference to FIG. 8. In FIG. 8, a message 400 used for the inter-node control protocols such as GMPLS and O-UNI, is formed by a common header 401 and a message body 402. The common header 401 includes a message length 403, a message type 404, and other information. The length of the message is determined by the message length 403 and the type of the message is determined by the message type 404.

The message body 402 is formed by plural objects 405 to 406. The objects 405 to 406 each include an object header 407 and an object's contents 408. The object header 407 stores an object length 409, a class number 410, a class type 411 and other information. Here the object type is determined by a combination of the class number 410 and the class type 411. The object's contents 408 stores information necessary for each message.

In the case of the path establishment message in enforcement mode, a code such as a character string indicating the path establishment message (enforcement mode) is stored in the message type 404 in order to define that the path establishment is in the enforcement mode. Also in the case of the temporary reply to be transmitted when the adjacent node is in a failure state, a code such as a character string indicating the temporary reply is stored in the message type 404 in order to determine whether it is the temporary reply or normal reply. In the case of the path establishment message (enforcement mode), the path establishment condition specification object 406 is stored in the message body 402 to specify a path establishment repeat condition and other conditions. In the object's contents 408 within the condition specification object 406, the specified condition is expressed by a combination of a function code 412 and a function 413.

Incidentally plural conditions may be specified by storing plural combinations of the function code 412 and the function 413 into the object's contents 408. It may be determined that the mode is the enforcement mode when a code indicating an existing message, such as a path establishment request message, is specified in the message type 404 and the path establishment condition specification object 406 exists within the message body 402. Also it may be determined that the message is the temporary reply when an existing value indicating a temporary reply message is used for the message type 404 and the path establishment condition specification object 406 exists.

Next, the contents of the object of the inter-node control protocol will be described with reference to FIG. 9. In FIG. 9, the combinations of the class number 410 of “1” and the class type 411 of “100” are used to specify conditions to the path establishment request message in enforcement mode. In this case, when the function code 412 is “1”, the information representing Priority is stored in the function 413. In Priority there is stored information indicating whether to treat all the conditions as “AND condition” or “OR condition” when plural condition specification objects are specified. When the class number 410 is “1” and the function code 412 is “2”, the waiting time to the start of the repeat process and the like is specified as an Interval value. When the class number 410 is “1” and the function code 412 is “3”, the elapse time condition from the reception of the temporary path establishment completion message is specified as a Repeat Time value. When the class number 410 is “1” and the function code 412 is “4”, the number of times the adjacent path establishment process is repeated is specified as a Repeat Count value. When the class 410 is “1” and the function code 412 is “5”, the information specifying the repeat interval is stored as a Repeat Interval value. When the class number 410 is “1” and the function code 412 is “6”, the information representing the reception waiting is stored as an operator trigger. The operator trigger is operated by an instruction transmitted in response to an instruction from the monitoring controller 251 and the like.

The combination of the class number 410 of “1” and the class type 411 of “101” represents a temporary path establishment reply message. In this case “1” is stored in the function code 412 and a code such as a character string indicating the temporary path establishment reply message is stored in the function 413.

The combination of the class number 410 of “1” and the class type 411 of “102” represents a temporary path establishment completion message. In this case “1” is stored in the function code 412 and a code such as a character string indicating the temporary path establishment completion message is stored in the function 413.

There may be used any other values for the combinations of the class number 410, class type 411, function code 412, and function 413, as long as the necessary process contents can be uniquely identified.

Next, the enforcement path establishment process will be described with reference to FIG. 10. In FIG. 10, the user node 110-1 receives a path establishment request of enforcement mode with the user node 110-3 as the destination node, having the conditions that the repeat interval is 1 second and the repeat count is 10. Then the user node 110-1 determines the path establishment mode of the received path establishment request (T801). Here the user node 110-1 determines that the mode is the enforcement mode, and performs the routing calculation process (T802). The user node 110-1 transmits a path establishment request message (enforcement) to the adjacent GMPLS node 101-1 on the calculated route (T803). After transmission of the path establishment request message (enforcement), the user node 110-1 performs the resource reservation process (T804).

The GMPLS node 101-1 receives the path establishment request message (enforcement), and determines the path establishment mode of the received path establishment request (T806). Here the GMPLS node 101-1 determines that the mode is the enforcement mode, and performs the routing calculation process (T807). The GMPLS node 101-1 transmits a path establishment request message (enforcement) to the GMPLS node 101-3 as the adjacent node on the route according to the specifications of the GMPLS protocol and the routing protocol (T808). After transmission of the path establishment request message (enforcement), the GMPLS node 101-1 performs the resource reservation process (T809).

The GMPLS nodes 101-3 receives the path establishment request message (enforcement), and determines the path establishment mode of the received path establishment request (T811). Here the GMPLS node 101-3 determines that the mode is the enforcement mode, and performs the routing calculation process (T812). The GMPLS node 101-3 transmits a path establishment request message (enforcement) to the adjacent user node 110-3 (T813). After transmission of the path establishment request message (enforcement), the GMPLS node 101-3 performs the resource reservation process (T814).

However, the user node 110-3 is in a reply disabled state due to a system down, so that the GMPLS node determines that the user node is in a failure state by the user node failure determination process (T815). Then the GMPLS node 101-3 performs the XC setting process (T816), and transmits a temporary path establishment reply message to the GMPLS node 101-1 (T817).

The GMPLS node 101-1 receives the temporary path establishment reply message, and performs the XC setting process to the resource reserved by the resource reservation process (T819). Then the GMPLS node 101-1 transmits a temporary path establishment reply message to the user node 110-1 (T820)

The user node 110-1 receives the temporary path establishment reply message, and performs the XC setting process to the resource reserved by the resource reservation process (T822). Then the user node 110-1 transmits a temporary path establishment completion message to the GMPLS node 101-1 (T823). The GMPLS node 101-1 receives the temporary path establishment completion message, and transmits a temporary path establishment completion message to the GMPLS node 101-3 (T825). Upon reception of the temporary path establishment completion message, the GMPLS node 101-3 starts the retry control. Here, since the conditions are specified in the path establishment request that the repeat interval is 1 second and the repeat count is 10, the GMPLS node 101-3 transmits path establishment request messages (enforcement) to the user node 110-3 at an interval of 1 second according to the specified conditions (T827 to T829).

When the user node 110-3 is recovered from the system down and receives the path establishment request message (enforcement), the user node 110-3 determines the path establishment mode of the received path establishment request (T831). Here the user node 110-3 determines that the mode is the enforcement mode, and performs the routing calculation process (T832). The user node 110-3 performs the resource reservation process (T833), the XC setting process (T834), and then transmits a path establishment reply message to the GMPLS node 101-3 (T835).

Upon reception of the path establishment reply message from the user node 110-3, the GMPLS node 101-3 transmits a path establishment completion message (notification) to the GMPLS node 101-1 (T837), and also transmits the path establishment completion message (notification) to the user node 110-3 (T838).

The GMPLS node 101-1 receives the path establishment completion message (notification), and transmits a path establishment completion message (notification) to the user node 110-1 (T840).

Incidentally, in transition 822, the user node 101-1 may perform the XC setting process to the core network (backup) 701-2, calculating an alternate route through the core network (backup) 701-2 for the purpose of traffic protection. When the user node 110-1 has performed the XC setting for the alternate route through the core network (backup) 701-2 in the XC setting process (T822) after receiving the path establishment completion message (notification), it is possible to change to the XC setting for the core network (working) 701-1 in the XC setting process and complete the path establishment (T842). When the user node 110-1 performed the XC setting for the core network (working) 701-1 in the XC setting process (T822), the XC setting process (T842) may be omitted. Further, the results of the processes may be notified as events to the monitoring controller 251 according to necessity. The resource reservation process in the user node 110-3 may be omitted.

Next, the enforcement path establishment process will be described with reference to FIG. 11. In FIG. 11, the user node 110-1 receives a path establishment request with the conditions that the repeat interval is 1 second and the repeat count is 3. Upon reception of the path establishment request, the user node 110-1 starts transferring a path establishment request message (enforcement). However T901 to T929 are the same as T801 to T829 shown in FIG. 8, so that the description will be omitted.

The GMPLS node 101-3 transmitted a path establishment request message (enforcement) to the user node 110-3 three times, but has no reply from the user node 110-3. Thus the GMPLS node 101-3 releases the resource by an XC deletion process (T930), and transmits a path deletion request message to the GMPLS node 101-1 (T931). After receiving the path deletion request message, the GMPLS node 101-1 releases the resource by the XC deletion process (T933), and transmits a path deletion request message to the user node 110-1 (T934). After receiving the path deletion request message, the user node 110-1 releases the resource by performing the XC deletion process (T936).

Incidentally the results of the processes may be notified as events to the monitoring controller 251 according to necessity.

According to the above described embodiment, by performing path establishment in the enforcement mode specified in the case where the destination node is in a failure or another undesirable state, it is possible to accomplish the path establishment process even if the destination node is in a failure state or another undesirable state. By securing the resource of the intermediate route, it is possible to avoid resource competition due to resource occupation by another user, even if the destination node is in a failure state. By transmitting a message to the request source node to notify that the retry process is being performed by the destination node and the adjacent node, the request source node can know that the path is uncompleted, making it possible to quickly perform traffic protection by an immediate calculation of an alternate route, and the like. By manually or automatically establishing the path of the remaining section after the destination node returns to normal state such as recovery from failure, it is possible to establish the paths of the entire section without performing path deletion. By notifying the request source node that the path establishment to the destination node is completed, the request source node can know completion of the path establishment, making it possible to automate the start of the operation of the main signal traffic and other operations. By releasing the resource of the intermediate route when the destination node does not return to be normal within the specified retry conditions, it is possible to prevent unnecessary occupation of the resource on the intermediate route. By notifying the monitoring controller 251 of the path generation state, the operator can correctly know the state of the path and identify the failed part.

According to the present invention the path establishment can be automatically performed when the node returns to normal state. Thus it is possible to achieve an efficient path establishment operation.

We claim:

1. A method for setting a path that comprises the steps of:
upon reception of a first path establishment request of enforcement mode, transmitting a second path establishment request to an adjacent node;
determining a failure of said adjacent node;
upon determination that a failure exists in communication with said adjacent node, transmitting a temporary path establishment reply to a source of said first path establishment request; and
upon reception of completion of the temporary path establishment from said source, transmitting a third path establishment request to said adjacent node according to conditions described in said temporary path establishment completion.

2. The method for setting a path according to claim 1, further comprising the step of transmitting a second path establishment reply to said source upon reception of the first path establishment reply from said adjacent node.

3. The method for setting a path according to claim 1, further comprising the step of transmitting a path deletion request to said source, when no path establishment request is received from said adjacent node under said conditions.

4. A node apparatus comprising:
a message reception unit;
a message transmission unit; and
an adjacent node state determination unit,
wherein when said message reception unit receives a first path establishment request of enforcement mode, said message transmission unit transmits a second path establishment request to an adjacent node,
when said adjacent node state determination unit determines that a failure exists in communication with said adjacent node, said message transmission unit transmits a temporary path establishment reply to a source of said first path establishment request, and
when said message reception unit receives completion of temporary path establishment from said source, said message transmission unit transmits a third path establishment request to said adjacent node according to conditions described in said temporary path establishment completion.

5. The node apparatus according to claim 4,
wherein when said message reception unit receives a path establishment reply from said adjacent node, said message transmission unit transmits a second path establishment reply to said source.

6. The node apparatus according to claim 4,
wherein when said message reception unit does not receive a path establishment reply from said adjacent node under said conditions, said message transmission unit transmits a path deletion request to said source.
